(19) United States
(12) Patent Application Publication
(10) Pub. No.: US 2026/0287882 A1
(43) Pub. Date: Sep. 24, 2026

(54) Wavelength-Tunable Interference Filter

(71) Applicant: SEIKO EPSON CORPORATION, Tokyo (JP)

(72) Inventors: Mitsumi KISHIDA, Shiojiri (JP); Kei KUDO, Shiojiri (JP)

(21) Appl. No.: 19/569,386

(22) Filed: Mar. 17, 2026

(30) Foreign Application Priority Data
Mar. 18, 2025 (JP) 2025-043294

(51) Int. Cl. G02B 26/00

(52) U.S. Cl. CPC G02B 26/001

(57) ABSTRACT

A wavelength-tunable interference filter includes a first substrate on which a first mirror is disposed; a movable portion including a second mirror facing the first mirror; a support configured to support the movable portion in a way that the movable portion is movable forward and rearward with respect to the first mirror; an outer peripheral portion configured to hold the movable portion via the support; an actuator configured to change a size of a gap between the first mirror and the second mirror; a detector provided at the support and configured to detect an amount of deformation of the support; and a controller, and the controller is configured to calculate the size of the gap based on the amount of deformation detected by the detector and drive the actuator based on the calculated size of the gap.

The present application is based on, and claims priority from JP Application Serial Number 2025-043294, filed Mar. 18, 2025, the disclosure of which is hereby incorporated by reference herein in its entirety.

### BACKGROUND

### 1. Technical Field

The present disclosure relates to a wavelength-tunable interference filter.

### 2. Related Art

There is a known wavelength-tunable interference filter of related art including a first substrate on which a diaphragm is formed, a second substrate, a first mirror provided at the first substrate, and a second mirror provided at the second substrate and facing the first mirror via a first gap (for example, refer to JP-A-2021-001965). The wavelength-tunable interference filter further includes a first electrode provided at the first substrate, and a second electrode provided at the second substrate. When a voltage is applied to the gap between the first electrode and the second electrode, an electrostatic attractive force acts between the first electrode and the second electrode to change the dimension of the first gap.

In the wavelength-tunable interference filter disclosed in JP-A-2021-001965, the first electrode is disposed at the diaphragm of the first substrate. When capacitance detecting electrodes that detect the first gap are provided, the electrodes are provided at the surfaces of the first and second mirrors.

JP-A-2021-001965 is an example of the related art.

In the wavelength-tunable interference filter disclosed in JP-A-2021-001965 described above, however, disposing the capacitance detecting electrodes at the surfaces of the first and second mirrors may affect the characteristics of the mirrors. When a voltage is applied to the gap between the first electrode and the second electrode, the diaphragm is deformed, so that the first electrode is bent. The capacitance between the first electrode and the second electrode therefore is position variant, so that it is difficult to control the gap.

In place of the configuration described above, it is also conceivable to dispose the capacitance detecting electrodes and the first electrode at a movable portion held by the diaphragm. In this case, however, the first mirror, the capacitance detecting electrodes, and electrodes that constitute an electrostatic actuator need to be disposed at the movable portion, so that the area of the electrodes that constitute the electrostatic actuator is restricted, resulting in a decrease in the distance over which the movable portion is movable.

### SUMMARY

A wavelength-tunable interference filter according to a first application example includes a first substrate on which a first mirror is disposed; a movable portion including a second mirror facing the first mirror; a support configured to support the movable portion in a way that the movable portion is movable forward and rearward with respect to the first mirror; an outer peripheral portion configured to hold the movable portion via the support; an actuator configured to change a size of a gap between the first mirror and the second mirror; a detector provided at the support and configured to detect an amount of deformation of the support; and a controller, and the controller is configured to calculate the size of the gap based on the amount of deformation detected by the detector and drive the actuator based on the calculated size of the gap.

### BRIEF DESCRIPTION OF THE DRAWINGS

FIG. 1 is a cross-sectional view showing a schematic configuration of a wavelength-tunable interference filter according to a first embodiment.

FIG. 2 is a plan view showing a second substrate shown in FIG. 1.

FIG. 3 illustrates an example of the arrangement of a detection circuit shown in FIG. 2.

FIG. 4 is a circuit diagram of the detection circuit shown in FIG. 3.

FIG. 5 illustrates another example of the arrangement of the detection circuit shown in FIG. 2.

FIG. 6 is a circuit diagram of the detection circuit shown in FIG. 5.

FIG. 7 is a plan view showing a schematic configuration of a wavelength-tunable interference filter according to a second embodiment.

FIG. 8 illustrates an example of the arrangement of a detection circuit shown in FIG. 7.

FIG. 9 is a plan view showing another example of the arrangement of the detection circuit in the second embodiment.

FIG. 10 illustrates an example of the arrangement of the detection circuit shown in FIG. 9.

FIG. 11 is a circuit diagram of the detection circuit shown in FIG. 10.

FIG. 12 is a plan view showing a schematic configuration of a wavelength-tunable interference filter according to a third embodiment.

FIG. 13 is a cross-sectional view showing a schematic configuration of a wavelength-tunable interference filter according to a fourth embodiment.

FIG. 14 is a plan view showing a second substrate shown in FIG. 13.

FIG. 15 is a cross-sectional view showing a schematic configuration of a wavelength-tunable interference filter according to Variation 2.

FIG. 16 is a cross-sectional view showing a schematic configuration of another example of the wavelength-tunable interference filter according to Variation 2.

### DESCRIPTION OF EMBODIMENTS

### First embodiment

### Configuration of wavelength-tunable interference filter 1

A first embodiment will be described below.

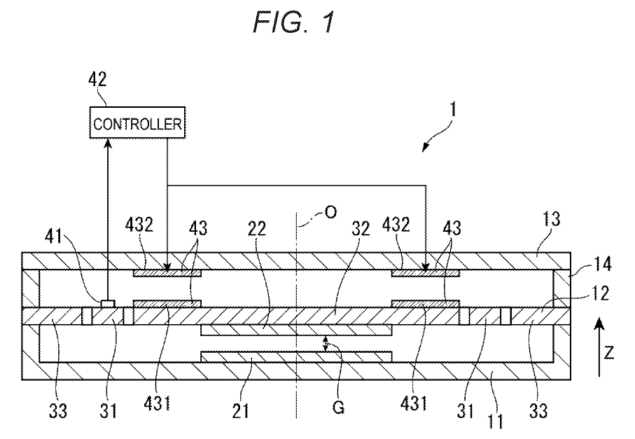

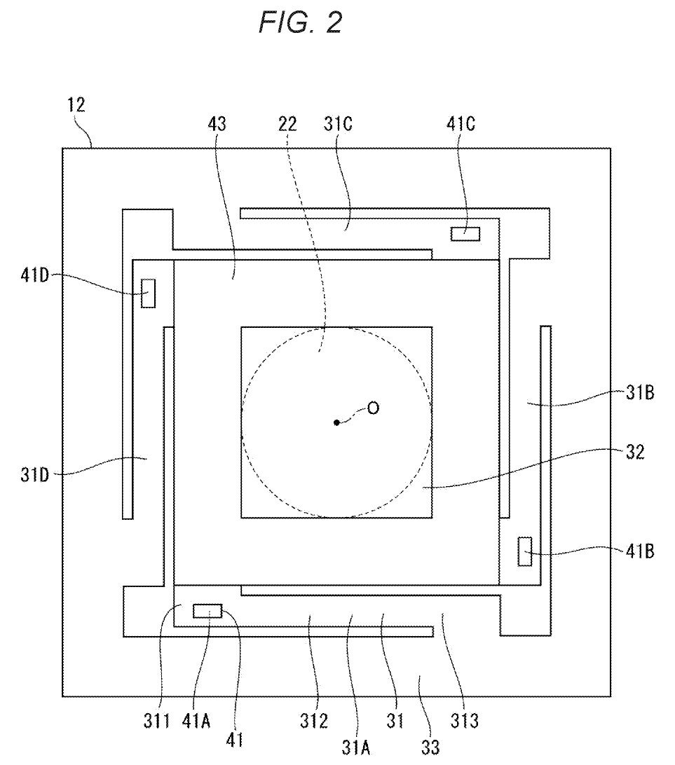

FIG. 1 is a cross-sectional view showing a schematic configuration of a wavelength-tunable interference filter 1 according to the present embodiment. FIG. 2 is a plan view of a second substrate 12 in FIG. 1.

In FIGS. 1 and 2, the wavelength-tunable interference filter 1 includes a first substrate 11, a second substrate 12, a first mirror 21 provided at the first substrate 11, a second mirror 22 provided at the second substrate 12, a third substrate 13, a detector 41, a controller 42, and an actuator 43. The first substrate 11 and the second substrate 12 are substrates that hold the first mirror 21 and the second mirror 22 in a way that the mirrors face each other via a gap G. The wavelength-tunable interference filter 1 is a Fabry-Perot etalon element that outputs light having a predetermined wavelength according to the dimension of the gap G out of light incident on the first mirror 21 and the second mirror 22.

Note in the following description that the center points of the first mirror 21 and the second mirror 22 coincide with each other in the plan view shown in FIG. 2, and a center axis of the first mirror 21 and the second mirror 22 that passes through the center points is referred to as a filter center axis O. The filter central axis O is an axis parallel to the Z-axis direction extending through the first substrate 11 toward the second substrate 12.

The first substrate 11 is formed, for example, in a substantially square shape in the plan view. The first substrate 11 is formed in the shape of a planar plate. The second substrate 12 is formed, for example, in a substantially square shape in the plan view, as shown in FIGS. 1 and 2.

The first substrate 11 has a surface facing the second substrate 12 and provided with a recess formed, for example, by etching, and the first mirror 21 formed, for example, in a substantially circular shape is provided at the bottom surface of the recess. A predetermined gap G is thus formed between the first mirror 21 and the second mirror 22.

Note that the first substrate 11 may have no recess. In this case, a spacer that forms the gap G may be disposed between the first substrate 11 and the second substrate 12, and the first substrate 11 and the second substrate 12 may be bonded to each other via the spacer.

The second substrate 12 includes a support 31, a movable portion 32, and an outer peripheral portion 33. The movable portion 32 is formed in a substantially square shape in the plan view. The second mirror 22 is disposed at a surface of the movable portion 32 that is the surface facing the first substrate 11.

The support 31 is made of an elastically deformable material, and supports movable portion 32 in a way that the movable portion 32 is displaceable in a Z direction, that is, the movable portion 32 is movable forward and rearward with respect to the first mirror 21. For example, in the present embodiment, the support 31, the movable portion 32, and the outer peripheral portion 33, which constitute the second substrate 12, are formed by an elastically deformable silicon substrate, and the support 31 is formed by forming a groove in the second substrate 12, for example, by punching. The support 31 is elastically deformed to allow the movable portion 32 to be displaced in the Z direction.

More specifically, the support 31 is disposed outside the movable portion 32, and links the outer peripheral portion 33 and the movable portion 32 to each other to support the movable portion 32 in a way that the movable portion 32 is displaceable in the Z direction. In the present embodiment, the support 31 is a beam-shaped member that links the outer peripheral portion 33 and the movable portion 32 to each other, and is configured with multiple portions. For example, the support 31 is configured with four portions in total in the present embodiment, a support 31A, a support 31B, a support 31C, and a support 31D. The supports 31A, 31B, 31C, and 31D extend along the respective sides of the movable portion 32. The multiple portions of the support 31 are coupled to the respective sides of the movable portion 32. That is, the multiple supports 31A, 31B, 31C, and 31D are disposed in a rotationally symmetrical manner (at 90-degree angular intervals in the present example) with respect to the filter central axis O.

The multiple portions of the support 31 each include a first piece 311, a second piece 312, and a third piece 313. The first piece 311 extends outward (toward outer peripheral portion 33) from each side of the movable portion 32. The second piece 312 extends from an outer end of the first piece 311 along each side of the movable portion 32. The third piece 313 extends outward from an end of the second piece 312 that is the end opposite the first piece 311, and is coupled to the outer peripheral portion 33.

Note that the support 31 only need to have a spring-like structure in which the support 31 itself is elastically deformed to displace the movable portion 32 in the Z direction, and does not necessarily have the aspect described above. For example, the support 31 may each be formed in a serpentine shape between one side of the movable portion 32 that is the side coupled to the support 31 and one side of the outer peripheral portion 33 that is the side facing one side of the movable portion 32. That is, multiple sets of the first piece 311, the second piece 312, and the third piece 313 may be continuously disposed, and the larger the number of turns of the serpentine shape, the wider the range over which the movable portion 32 is displaced.

The outer peripheral portion 33 is disposed outside the support 31. The outer peripheral portion 33 is coupled to the ends of the third pieces 313 as described above, and holds the movable portion 32 via the support 31. The outer peripheral portion 33 is further coupled to the first substrate 11 and the third substrate 13 via bonding films (not shown).

### Structure of detector

The detector 41 is an element that detects the amount of deformation of the support 31. In the present embodiment, the detector 41 is, for example, a resistor having electrical resistance that changes due to a bend (deformation) of the support 31. Examples of the resistor may include a piezoelectric resistor and a metal film. When a piezoelectric resistor is used as the resistor, boron or phosphorus is doped into the silicon substrate that forms the support 31, for example, by ion implantation. When a metal film is used as the resistor, a metal having a resistance value that changes due to its deformation is used. Examples of the metal film may include films made of nickel-chromium alloy, platinum, gold, silver, and indium tin oxide (ITO).

The detector 41 may be provided at at least one of the four portions of the support 31 (31A, 31B, 31C, and 31D) as long as the four portions of the support 31 (31A, 31B, 31C, and 31D) are deformed by the same amount. In the present embodiment, a configuration in which the four portions of the support 31 are each provided with the detector 41 is presented by way of example. That is, in the present embodiment, a detector 41A provided at the support 31A, a detector 41B provided at the support 31B, a detector 41C provided at the support 31C, and a detector 41D provided at the support 31D are provided.

The detector 41 is preferably disposed at a position of the support 31 where the amount of the deformation due to the bend is greater than those at the other positions. For example, in the present embodiment, the detector 41 is disposed at a position at the boundary between each of the first pieces 311 and the corresponding second piece 312.

In addition, the detector 41 may be disposed at the front surface of the support 31 (a surface facing third substrate 13), may be disposed at the rear surface of the support 31 (a surface facing first substrate 11), or may be provided at both the front surface and the rear surface of the support 31. In the present embodiment, the detector 41 is disposed at the front surface of the support 31 by way of example. Note that the aspect in which the detector 41 is provided at the rear surface of the support 31 and the aspect in which the detector 41 is provided at both the front and rear surfaces of the support 31 will be described later.

### Configuration of circuit

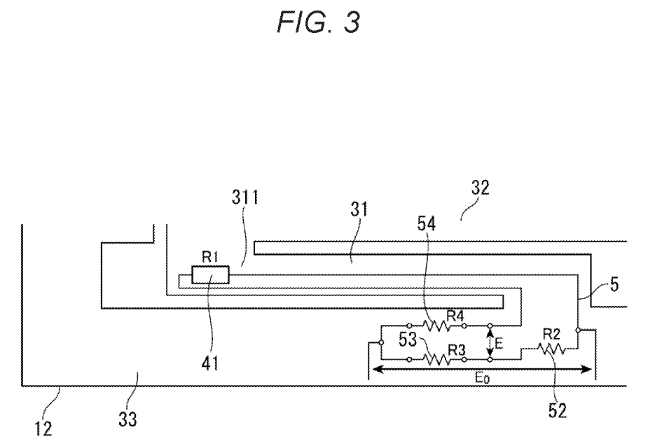

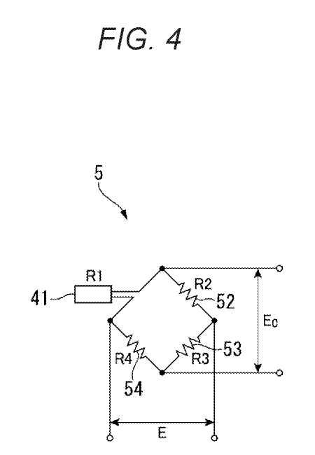

FIG. 3 is a partially enlarged view of FIG. 2 and shows the arrangement of a detection circuit 5. FIG. 4 is a circuit diagram of the detection circuit 5.

The wavelength-tunable interference filter 1 includes at least one detection circuit 5, which detects the electric resistance value of the detector 41 as a resistor. In the present embodiment, the detection circuit 5 includes at least one detector 41 of the multiple detector 41. In the following description, let R1 be the electric resistance value of the detector 41.

The detection circuit 5 includes the detector 41 having the electric resistance value R1, a resistor 52 having an electric resistance value R2, a resistor 53 having an electric resistance value R3, and a resistor 54 having an electric resistance value R4. In the detection circuit 5, the resistors 52, 53, and 54 are preferably disposed at the outer peripheral portion 33, where the amount of bend is small.

In the detection circuit 5, the detector 41 (R1) constitutes a portion of a Wheatstone bridge circuit, as shown in FIG. 4. Specifically, the detection circuit 5 is a one-gauge, two-wire strain gauge circuit including a Wheatstone bridge circuit configured with the detector 41, and the resistors 52, 53, and 54. In the detection circuit 5, a voltage E is input to the gap between the detector 41 (electric resistance value R1) and the resistor 54 (electric resistance value R4) and between the resistor 52 (electric resistance value R2) and the resistor 53 (electric resistance value R3). An output voltage E₀ is thus produced between the detector 41 and the resistor 52 and between the resistor 53 and the resistor 54. In the detection circuit 5, the detector 41 is configured as an active gauge. The detection circuit 5 can thus detect the amount of change in the electrical resistance value R1 of the detector 41.

In the present embodiment, a total of four detection circuits 5 are disposed at the sides of the second substrate 12. The deformation of each of the supports 31A, 31B, 31C, and 31D can therefore be detected. The controller 42 can therefore detect an inclination of the movable portion 32 based on the results of the detection performed by the multiple detection circuits 5.

Returning to FIGS. 1 and 2, the third substrate 13 is disposed on a side of the second substrate 12 that is the side opposite the first substrate 11 and is bonded to the outer peripheral portion 33. The third substrate 13 holds the second substrate 12 via a support column 14. The third substrate 13 is disposed so as to face the second substrate 12 via a predetermined gap.

The actuator 43 is disposed at the second substrate 12 and the third substrate 13. Specifically, the actuator 43 is an electrostatic actuator including a first electrode 431 disposed at the movable portion 32 of the second substrate 12 and a second electrode 432 disposed at the third substrate 13 so as to face the first electrode 431. In the thus configured actuator 43, an electrostatic attractive force is generated between the third substrate 13 and the second substrate 12 when a voltage is applied to the gap between the first electrode 431 and the second electrode 432. The movable portion 32 is thus displaced toward the third substrate 13, so that the size of the gap G is changed.

The controller 42 calculates the amount of deformation of the support 31 based on the amount of change in the electric resistance value R1 of the detector 41 detected by the detection circuit 5. The controller 42 further calculates the amount of displacement of the movable portion 32 in the Z direction based on the amount of deformation of the support 31, and controls the drive voltage applied to the actuator 43 in a way that the amount of displacement becomes a desired target value, and drives the actuator 43.

### Operation of wavelength-tunable interference filter 1

Regarding the operation of the wavelength-tunable interference filter 1, a method for detecting the gap G will next be described. For example, upon reception of command information issued by a user through an input operation or the like and used to drive the wavelength-tunable interference filter 1, the controller 42 applies a drive voltage according to a target wavelength to the actuator 43. The command information may be a command that causes the wavelength-tunable interference filter 1 to separate a desired target wavelength, or a command that causes the wavelength-tunable interference filter 1 to sequentially change the wavelength of the light to be separated from one to another. To cause the wavelength-tunable interference filter 1 to sequentially change the wavelength of the light to be separated from one to another, the controller 42 changes the drive voltage applied to the actuator 43 so as to change the target wavelength at predetermined intervals.

In this process, the controller 42 acquires the output voltage E₀ output from each of the detection circuits 5 by inputting the voltage E to the detection circuit 5.

The application of the drive voltage to the actuator 43 bends the support 31, so that the movable portion 32 is displaced. The bending of the support 31 changes the electric resistance value R1 of the detector 41. Therefore, when the voltage E is input to each of the detection circuits 5, the output voltage E₀ according to the amount of change in the electric resistance value R1 of the detector 41 is output from the detection circuit 5. The controller 42 then calculates the relative distance of the gap G based on the output voltage E₀ output from each of the detection circuits 5.

For example, the controller 42 calculates the average of the electrical resistance values R1 of the detector 41 based on the output voltages E₀ from the detection circuits 5. The size of the gap G corresponding to the average of the electric resistance values R1 is measured in advance in the form of table data or the like, which is stored in a storage that is not shown. The size of the gap G corresponding to the calculated average of the electric resistance values R1 is then read from the table data stored in the storage.

The controller 42 then moves the movable portion 32 based on the calculated size of the gap G. That is, the controller 42 performs feedback control on the drive voltage applied to the actuator 43 in a way that the size of the gap G becomes a size corresponding to the target wavelength.

Note that the configuration in the present embodiment, in which the actuator 43 is provided with one first electrode 431 and one second electrode 432, may be replaced with a configuration in which the actuator 43 includes multiple first electrodes 431 and second electrodes 432 corresponding to the first electrodes 431, that is, a configuration in which the actuator 43 includes multiple partial actuators. In this case, drive voltages can be separately applied to the partial actuators.

In the method for detecting the gap G of the wavelength-tunable interference filter 1 described above, the size of the gap G is detected based on the average of the electric resistance values R1 of the multiple detector 41, and the amounts of bend of the multiple portions of the support 31 may be calculated from the electric resistance values R1 of the respective multiple detector 41. In this case, the inclination of the movable portion 32 can be calculated from the amounts of bending of the multiple portions of the support 31. In addition, the controller 42 can control the drive voltages applied to the partial actuators so as to correct the inclination of the movable portion 32.

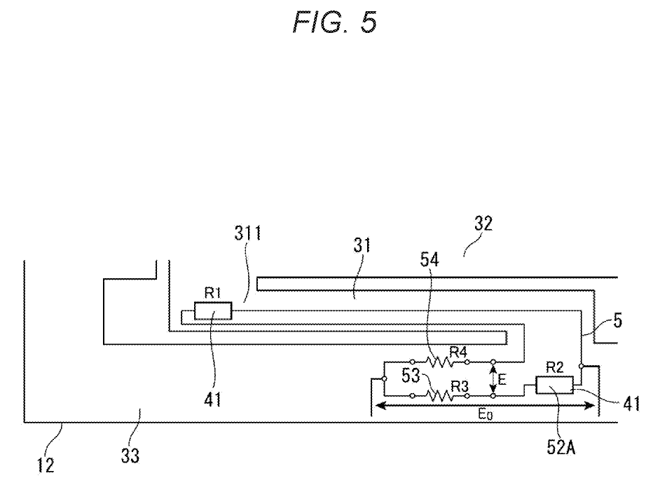

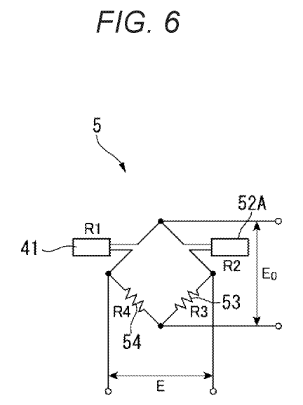

Note that the configuration in the present embodiment, in which the detection circuits 5 are each configured with the one-gauge, two-wire strain gauge circuit, may be replaced with a configuration in which the detection circuits 5 are each configured with a two-gauge strain gauge circuit. FIG. 5 is an example of the arrangement of the detection circuit 5 configured with a two-gauge strain gauge. FIG. 6 is a circuit diagram of the detection circuit 5 shown in FIG. 5.

The configuration in the present embodiment, in which the resistor 52 having the electric resistance value R2 is provided, may be replaced with a configuration in which the resistor 52 is configured as a detector. That is, the resistor 52 may function, for example, as a detector 52A having the electric resistance value R2, like the detector 41. In this case, the detector 52A is treated as a dummy gauge (reference detector) of the strain gauge, and is configured with a piezoelectric resistor, a metal film, or the like. That is, the detector 52A is treated as a reference detector with respect to the detector 41.

In this case, the detector 52A is disposed at the outer peripheral portion 33, as the resistor 52. The outer peripheral portion 33 is not displaced by the operation of the actuator 43. The detector 52A therefore does not detect a bend due to the operation of the actuator 43. The second substrate 12 slightly bends in some cases due, for example, to a change in temperature. The electrical resistance value of the detector 52A changes when the second substrate 12 bends due to a change in temperature. The detector 52A can therefore detect a bend of the second substrate 12 resulting from a cause other than the bend due to the operation of the actuator 43.

The controller 42 can therefore calculate only the amount of bend due to the operation of the actuator 43 out of various bending detected by the detector 41 at the support 31 by comparing a change in the electric resistance value of the detector 52A with a change in the electric resistance value of the detector 41 at the support 31. That is, a change in the electric resistance value of the detector 41 due to the strain caused by a change in temperature can be cancelled out.

The detection circuits 5 can thus each be a detection circuit 5 having temperature compensation capability, so that the wavelength-tunable interference filter 1 can detect the gap G with higher accuracy. Similarly, the detection circuits 5 can thus each be a detection circuit 5 having lead wire temperature compensation capability. The thus configured wavelength-tunable interference filter 1 can therefore also readily control the gap G and widen the range of the wavelength of the spectrally separated light while achieving high accuracy of the wavelength of the spectrally separated light.

### Effects and advantages of present embodiment

(1) The wavelength-tunable interference filter 1 according to the present embodiment includes the first substrate 11, at which the first mirror 21 is disposed, the movable portion 32 including the second mirror 22 facing the first mirror 21, the support 31, which supports the movable portion 32 in a way that the movable portion 32 is movable forward and rearward with respect to the first mirror 21, the outer peripheral portion 33, which holds the movable portion 32 via the support 31; the actuator 43, which changes the size of the gap G between the first mirror 21 and the second mirror 22; the detector 41, which is provided at the support 31 and detects the amount of deformation of the support 31; and the controller 42, and the controller 42 calculates the size of the gap G based on the amount of deformation detected by the detector 41 and drives the actuator 43 based on the calculated size of the gap G, as described above.

The thus configured wavelength-tunable interference filter 1 can readily control the gap G and widen the range of the wavelength of the spectrally separated light while achieving high accuracy of the wavelength of the spectrally separated light.

That is, in the present embodiment, the first electrode 431, which constitutes the actuator 43, is provided not at the support 31 but at the movable portion 32. Therefore, even when the movable portion 32 is displaced in the Z direction, the distance between the first electrode 431 and the second electrode 432 of the actuator 43 does not vary, so that the actuator 43 can be readily controlled.

Furthermore, in the present embodiment, since the detector 41 is disposed at the support 31, it is unnecessary to provide the movable portion 32 with electrodes used to detect the gap G, and the electrode area of the first electrode 431 provided at the movable portion 32 can be increased accordingly. The electrostatic attractive force generated by the actuator 43 can therefore be increased, so that the range over which the movable portion 32 is displaceable can be widened. The range of the wavelength of the light spectrally separated by the wavelength-tunable interference filter 1 can therefore be widened.

Furthermore, in the present embodiment, the controller 42 calculates the size of the gap G based on the amount of deformation of the support 31 detected by the detector 41, and performs feedback-control on the actuator 43 based on the calculated size of the gap G.

The size of the gap G can therefore be controlled to a size corresponding to the target wavelength, so that the wavelength-tunable interference filter 1 can output light having a desired target wavelength.

(2) In the wavelength-tunable interference filter 1 according to the present embodiment, the detector 41 is a resistor having a resistance value that changes in accordance with the amount of deformation of the support 31, and the controller 42 calculates the size of the gap G based on the resistance value of the resistor.

In the configuration described above, the resistance value of the detector 41 changes in accordance with the bend (deformation) of the support 31. The amount of deformation of the support 31 can therefore be acquired from the change in the electric resistance value output from the detector 41.

(3) In the wavelength-tunable interference filter 1 according to the present embodiment, it is preferable to use a piezoelectric resistor as the detector 41.

In the configuration described above, when the support 31 is provided with a film member or the like, there is a risk that the film member peels off when the support 31 bends. However, using a piezoelectric resistor formed by implanting boron or phosphorus into a substrate eliminates the risk of peeling. The reliability of the wavelength-tunable interference filter 1 can therefore be improved.

(4) In the wavelength-tunable interference filter 1 according to the present embodiment, a metal film may be used as the detector 41.

In the configuration described above, the bend (amount of deformation) of the support 31 can be detected with the simple configuration in which only the metal film is formed.

(5) In the wavelength-tunable interference filter 1 according to the present embodiment, the detector 41 constitutes a portion of a Wheatstone bridge circuit.

In the configuration described above, the detector 41 can be configured as a strain gauge. A detection circuit 5 capable of detecting the amount of change in the resistance value of the detector 41 can therefore be configured.

(6) In the wavelength-tunable interference filter 1 according to the present embodiment, the controller 42 calculates the average of the amounts of deformation detected by the detector 41 and are disposed at at least two portions of the support 31, and calculates the size of the gap G based on the average.

In the configuration described above, the influence of noise can be suppressed by using the average of the amounts of deformation of the multiple portions of the support 31. Furthermore, the size of the gap G can be detected more accurately than when the amount of deformation is detected from one portion of the support 31.

(7) In the wavelength-tunable interference filter 1 according to the present embodiment, the detector 41 is disposed at one of the front surface and the rear surface of the support 31, as described above.

The configuration described above, for example, allows the detector 41 to detect the amount of displacement of the support 31 with the simple configuration as compared with a case where the detector 41 is disposed at opposite surfaces of the support 31.

### Second embodiment

A second embodiment will next be described.

In the first embodiment described above, the detector 41 and the detector 52A are disposed at the front surface (surface facing third substrate 13) of the support 31. In contrast, the present embodiment differs from the first embodiment in that the detector 41 and the detector 52A are provided at both the front surface and the rear surface of the support 31.

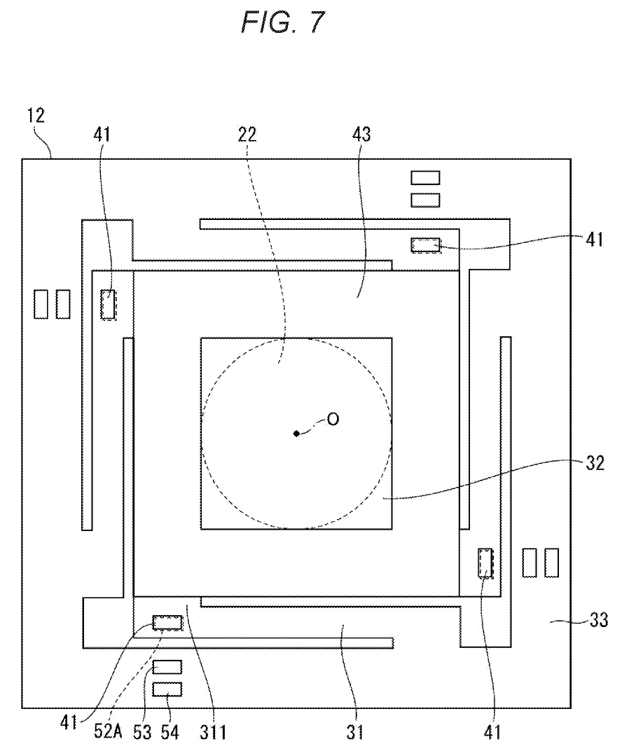

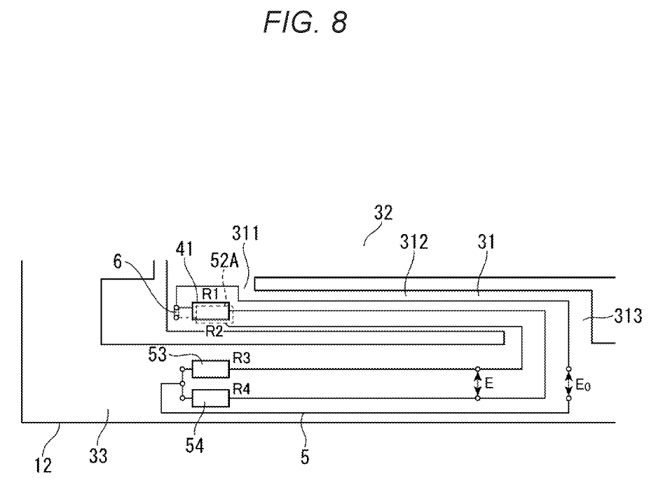

FIG. 7 is a plan view showing a schematic configuration of a wavelength-tunable interference filter 1 according to the second embodiment. FIG. 8 is a partially enlarged view of the second substrate 12 and shows the arrangement of each of the detection circuits 5 in FIG. 7.

Note in the description below that an element having already been described has the same reference character and will not be described or will be described in a simplified manner.

In the first embodiment, the detector 41 is disposed at the front surface of the second substrate 12, and may be disposed at both the front and rear surfaces. In the present embodiment, the detector 41 is disposed at the front surface of the support 31, and the detector 52A is disposed at the rear surface of the support 31. Specifically, the detector 41 and the detector 52A are disposed so as to face each other with the support 31 interposed therebetween.

The support 31 is provided with a conductive portion 6, which causes the detector 41 having the electric resistance value R1 and the detector 52A having the electric resistance value R2 to be electrically conductive with each other. The detector 41 having the electrical resistance value R1 and the detector 52A having the electrical resistance value R2 are thus electrically coupled to each other.

In the present embodiment, the detector 41 and the detector 52A are treated as strain gauges, and the detection circuits 5 are each configured as a two-gauge strain gauge circuit. By symmetrically arranging the strain gauges at the front surface and the rear surface of the support 31, when the support 31 bends, one of the detector 41 and the detector 52A contracts and the other expands. Therefore, even when the temperature changes, the influence of the change is canceled at the support 31, so that the output is not affected. The gap G can therefore be detected without being affected by the change in temperature. Similarly, the detection circuits 5 can thus each be a detection circuit 5 having lead wire compensation capability.

In addition, configuring each of the detection circuits 5 by using two strain gauges allows generation of an output voltage E₀ that is twice greater than that provided by using one strain gauge.

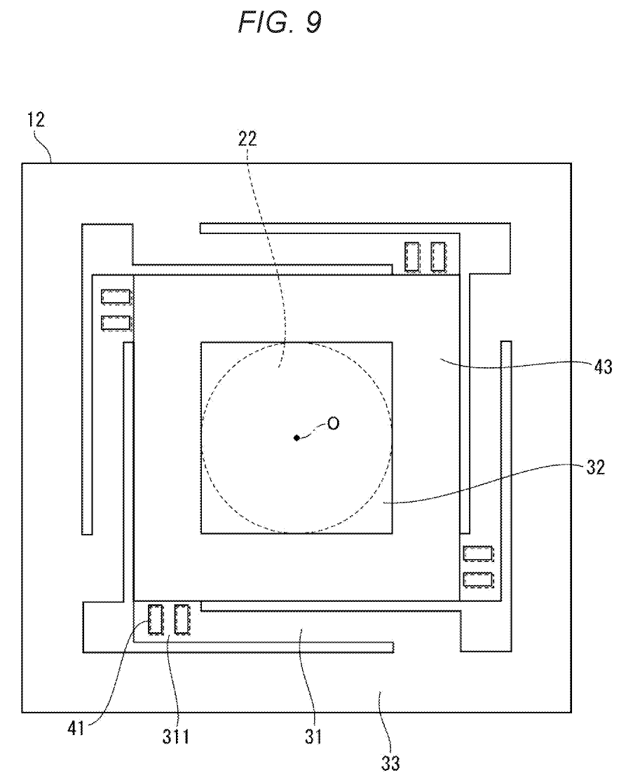

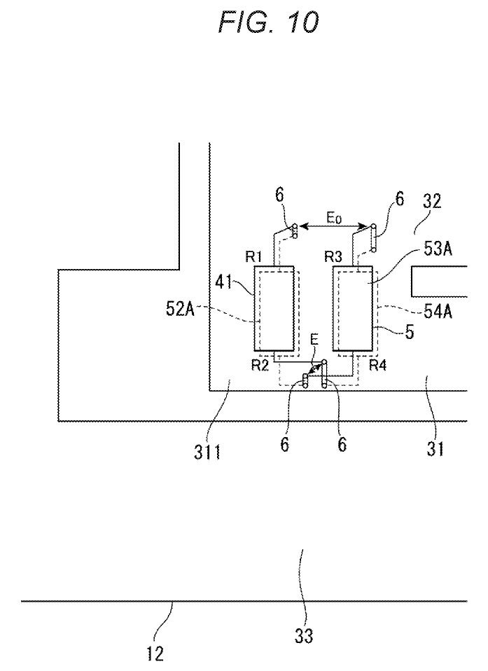

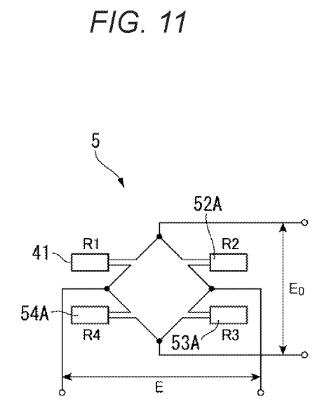

Note in the present embodiment that each of the detection circuits 5 is a two-gauge strain gauge circuit, and may instead be a four-gauge strain gauge circuit. FIG. 9 is a plan view of the wavelength-tunable interference filter 1 in which the detection circuits 5 are each configured with a four-gauge strain gauge. FIG. 10 is a partially enlarged view of FIG. 9, and illustrates an example of the arrangement of the detection circuit 5 in a case where the detection circuit 5 is configured with a four-gauge strain gauge. FIG. 11 is a circuit diagram of the detection circuit 5 shown in FIG. 10.

In the first embodiment described above, the resistor 53 having the electric resistance value R3 and the resistor 54 having the electric resistance value R4 are provided, and the resistors 53 and 54 may each be configured as a detector. That is, the resistors 53 and 54 may function as, for example, the detector 53A having the electric resistance value R3 and the detector 54A having the electric resistance value R4, as the detector 41 and the detector 52A. In this case, the detectors 53A and 54A are treated as dummy gauges of the strain gauges, and are each configured with a piezoelectric resistor, a metal film, or the like.

The detectors 41, 52A, 53A, and 54A are provided at the support 31. Specifically, in the present embodiment, the detectors 41, 52A, 53A, and 54A are disposed at the boundary between the first piece 311 and the second piece 312. The detector 41 and the detector 53A are disposed at the front surface of the support 31, and the detector 52A and the detector 54A are disposed at the rear surface of the support 31. The detector 41 and the detector 52A face each other via the support 31. The detector 53A and the detector 54A face each other via the support 31.

The support 31 is provided with the conductive portion 6 that causes the detectors 53A and 54A to be electrically conductive with each other, the conductive portion 6 that causes the detectors 52A and 53A to be electrically conductive with each other, and the conductive portion 6 that causes the detectors 41 and 54A to be electrically conductive with each other.

The detection circuits 5 are therefore each configured as a Wheatstone bridge circuit configured with a four-gauge strain gauge. The detection circuits 5 can each be a detection circuit 5 having temperature compensation capability, as in the embodiment described above. The detection circuits 5 can also each be a detection circuit 5 having lead wire temperature compensation capability. As a result, the full width at half maximum of a spectrum produced by the wavelength-tunable interference filter 1 is narrowed, so that the wavelength resolution is improved.

In addition, configuring each of the detection circuits 5 by using two strain gauges allows generation of an output voltage E₀that is four times greater than that provided by using one strain gauge.

The actuator 43 includes multiple partial actuators disposed in accordance with the positions of the multiple detection circuits 5. The controller 42 can calculate the inclination of the movable portion 32 from the amounts of bending of the portions of the support 31 detected by the multiple detection circuits 5. The controller 42 may separately drive the multiple partial actuators based on the calculated inclination of the movable portion 32. The controller 42 can therefore correct the inclination of the movable portion 32. That is, the controller 42 corrects the inclination of the second mirror 22 to increase the parallelism between the first mirror 21 and the second mirror 22. The thus configured wavelength-tunable interference filter 1 can therefore readily control the gap G and widen the range of the wavelength of the spectrally separated light while achieving high accuracy of the wavelength of the spectrally separated light.

### Effects and advantages of second embodiment

(1) In the wavelength-tunable interference filter 1 according to the present embodiment, the detector 41 is disposed at both the front surface and the rear surface of the support 31, as described above.

The configuration described above can provide an output voltage E₀ twice greater than that provided by the detection circuits 5 in the first embodiment. The detection circuits 5 can each be a detection circuit 5 having temperature compensation capability. The detection circuits 5 can also each be a detection circuit 5 having lead wire temperature compensation capability. The size of the gap G can therefore be detected more accurately. That is, the detector 41 disposed at the front surface (facing third substrate 13) of the support 31 can detect strain due to a change in compressive stress. The detector 41 disposed at the rear surface (facing first substrate 11) of the support 31 can detect strain due to a change in tensile stress. Integrating the configurations described above with each other allows the amount of deformation of the support 31 to be detected with higher accuracy.

### Third embodiment

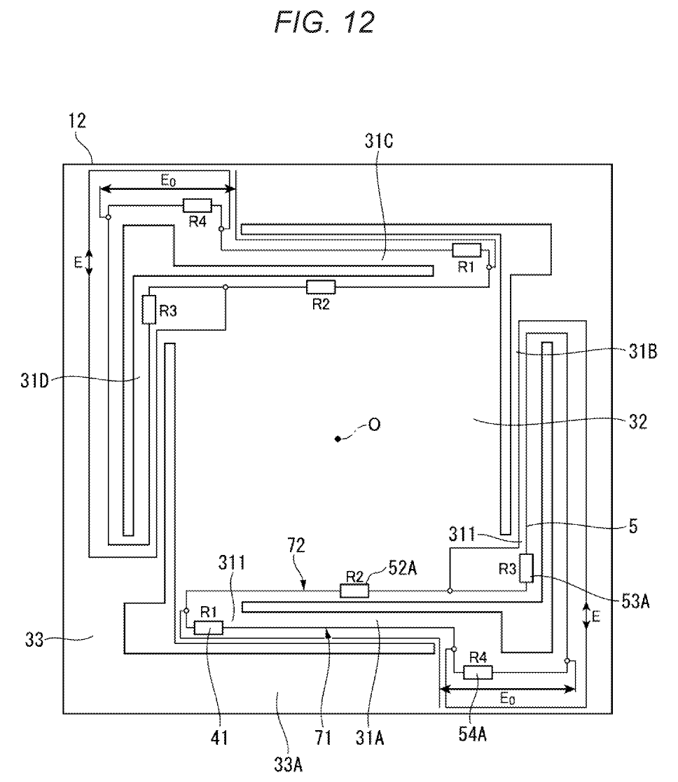

In the first embodiment, the detector 41 and are disposed at the portions of the support 31 include the detection circuits 5 independent of each other, and the controller 42 calculates the average of the electrical resistance values R1 of the detector 41. In contrast, a third embodiment differs from the first embodiment in that some of the detectors disposed at the portions of the multiple supports 31 are coupled to each other into one detection circuit 5. FIG. 12 is a plan view showing a schematic configuration of a wavelength-tunable interference filter 1 according to the third embodiment. Note that the second mirror 22 and the actuator 43 are omitted in FIG. 12.

In the present embodiment, the resistors 52, 53, and 54 are configured as the detectors 52A, 53A, and 54A. The detectors 41, 52A, 53A, and 54A are disposed at the front surface of the second substrate 12. In the present embodiment, two detection circuits 5 are provided. One of the two detection circuits 5 is disposed in a range extending over the movable portion 32, the support 31A, an outer peripheral portion 33A, and the support 31B, and couples the detector 41 disposed at the support 31A and the detector 53A disposed at the support 31B to each other. The other of the two detection circuits 5 is disposed in a range extending over the movable portion 32, the support 31C, the outer peripheral portion 33A, and the support 31D, and couples the detector 41 disposed at the support 31C and the detector 53A disposed at the support 31D to each other. The two detection circuits 5 are disposed rotationally symmetrically with respect to the filter central axis O.

In the one detection circuit 5, the detector 41 having the electrical resistance value R1 is disposed at the support 31A, and the detector 53A is disposed at the support 31B adjacent to the support 31A. The detector 52A is disposed at the movable portion 32, and the detector 54A is disposed at the outer peripheral portion 33A. The same applies to the other detection circuit 5.

The support 31 is provided with a first wiring 71, in which a conductive wire of the detection circuit 5 is disposed. The first wiring 71 is disposed along the second piece 312. The first wiring 71 is disposed at each of the multiple portions of the support 31. The detector 41 is electrically coupled to the conductive wire disposed in the first wiring 71 out of the conductive wires of the detection circuit 5.

The movable portion 32 is further provided with a second wiring 72, in which a conductive wire of the detection circuit 5 is disposed. In the present embodiment, the second wiring 72 is disposed along an edge of the movable portion 32. The detector 41 is electrically coupled to the conductive wire disposed in the second wiring 72 out of the conductive wires of the detection circuit 5.

The detection circuits 5 in the present embodiment are each configured as a four-gauge strain gauge circuit. In the present embodiment, the detector 52A and the detector 54A are each configured as a dummy gauge (reference detector) in the strain gauge circuit. That is, the detector 52A and the detector 54A are treated as reference detectors with respect to the detector 41 and the detector 53A. The detector 41 is electrically coupled to the detector 52A and the detector 54A. The controller 42 can therefore detect a change in the electrical resistance value according to the amount of deformation of the support 31A and a change in the electrical resistance value according to the amount of deformation of the support 31B.

### Effects and advantages of third embodiment

(1) In the wavelength-tunable interference filter 1 according to the present embodiment, multiple detector 41 are provided, and the multiple detector 41 are coupled to each other to form one detection circuit 5, as described above.

The configuration described above allows the detection circuit 5 to produce the output voltage E₀ based on the average of the electrical resistance values of two of the detector 41. Noise can therefore be reduced, so that the size of the gap G can be detected with high accuracy. The detection circuits 5 can each be a detection circuit 5 having temperature compensation capability. The detection circuits 5 can instead each be a detection circuit 5 having lead wire temperature compensation capability, so that the size of the gap G can be detected more accurately.

(2) In the wavelength-tunable interference filter 1 according to the present embodiment, multiple portions of the support 31 are provided, and the detector 41 is disposed at least at two of the portions of the support 31, as described above.

The configuration described above allows more accurate detection of the size of the gap G by detecting the amounts of deformation of the portions of the support 31 with two detectors (detector 41 having electric resistance value R1 and detector 53A having electric resistance value R3) instead of detecting the amount of deformation of the support 31 with one detector 41.

(3) In the wavelength-tunable interference filter 1 according to the present embodiment, the multiple portions of the support 31 are each provided with the first wiring 71, in which a conductive wire is disposed, the movable portion 32 is provided with the second wiring 72, in which a conductive wire is disposed, and the detector 41 is electrically coupled to the conductive wire disposed in the first wiring 71 and the conductive wire disposed in the second wiring 72, as described above.

The configuration described above allows the detection circuit 5 in which the detectors are disposed at two portions of the support 31 to form the detection circuit 5 with simple wiring.

In the first embodiment, both the conductive wire that couples the detector 41 to the resistor 52 at the outer peripheral portion 33 and the conductive wire that couples the detector 41 to the resistor 53 at the outer peripheral portion 33 are disposed at one portion of the support 31, as described above. In contrast, the third embodiment is preferable because the detection circuit 5 can be configured with simple wiring even when there is a restriction on the area of the support 31, particularly, a restriction on the width of one of the portions of the support 31.

(4) The detector 52A disposed for reference with respect to the detector 41 is further provided, the multiple portions of the support 31 are each provided with the first wiring 71, in which a conductive wire is disposed, the movable portion 32 is provided with the second wiring 72, in which a conductive wire is disposed, and the detector 41 is electrically coupled to the conductive wire disposed in the first wiring 71, the conductive wire disposed in the second wiring 72, and the detector 52A, as described above.

The configuration described above allows the detection circuit 5 in which the detectors are disposed at two portions of the support 31 to form the detection circuit 5 with simple wiring. Furthermore, providing the detector 52A for reference can configure the detection circuit 5 having temperature compensation capability.

In the first embodiment, both the conductive wire that couples the detector 41 to the resistor 52 at the outer peripheral portion 33 and the conductive wire that couples the detector 41 to the resistor 53 at the outer peripheral portion 33 are disposed at one portion of the support 31, as described above. In contrast, the third embodiment is preferable because the detection circuit 5 can be configured with simple wiring even when there is a restriction on the area of the support 31, particularly, a restriction on the width of one of the portions of the support 31.

### Fourth embodiment

A fourth embodiment will next be described.

In the first embodiment described above, an example of the configuration in which one actuator 43 is provided has been presented. In contrast, the present embodiment differs from the first embodiment in that multiple actuators 43 are provided.

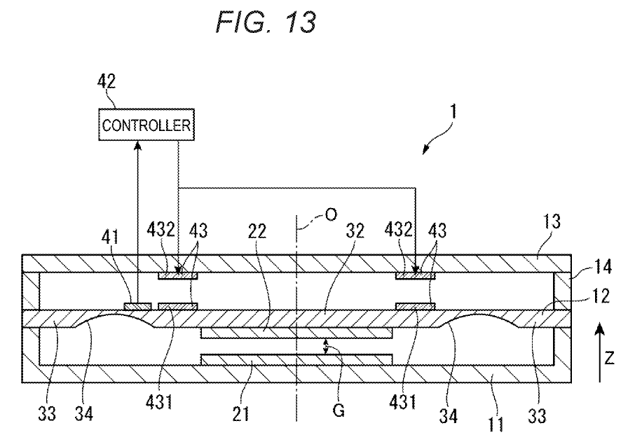

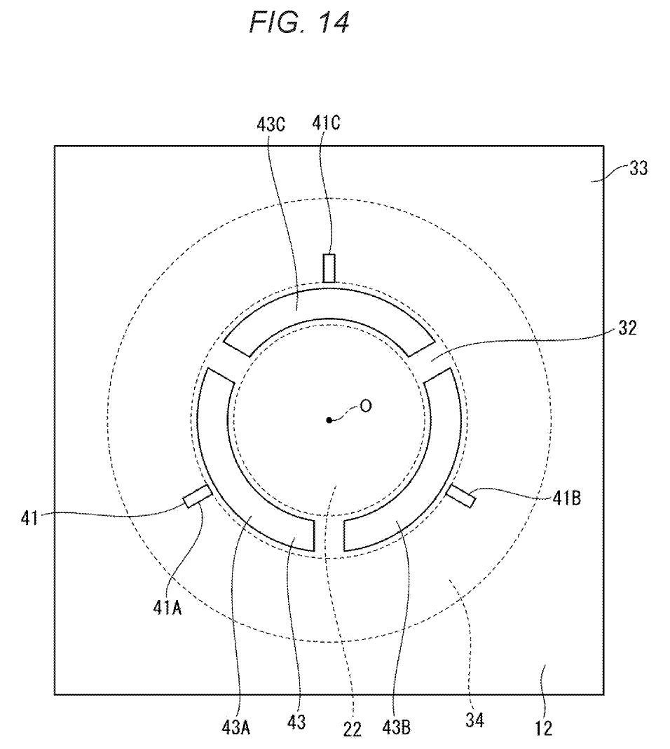

FIG. 13 is a cross-sectional view showing a schematic configuration of a wavelength-tunable interference filter 1 according to the present embodiment. FIG. 14 is a plan view showing the second substrate 12 shown in FIG. 13.

In the present embodiment, the support 31 is configured as a diaphragm 34, which surrounds the outer circumference of the movable portion 32.

In the present embodiment, the movable portion 32 is formed in a circular shape in the plan view, and the diaphragm 34 is formed in an annular shape that surrounds the movable portion 32. The diaphragm 34 can be formed, for example, by etching a portion of a surface of the second substrate 12 that is the surface facing the first substrate 11 into a concave portion. The bottom of the recessed groove formed by the etching is sufficiently smaller than the movable portion 32 and the outer peripheral portion 33. When the thus configured diaphragm 34 is deformed, the movable portion 32 can be displaced in the Z direction as in the first to third embodiments described above.

Note in the present embodiment that the diaphragm 34 is presented as the support 31 by way of example, and the support 31 may also be configured with the beam-shaped member described in the above first to third embodiments, which links the outer peripheral portion 33 and the movable portion 32 to each other.

In the present embodiment, the actuator 43 includes a partial actuator 43A, a partial actuator 43B, and a partial actuator 43C as the partial actuators. The first electrodes 431, which constitute the partial actuators 43A, 43B, and 43C, are disposed outside the second mirror 22 (away from filter central axis O) in the movable portion 32, as in the embodiments described above. The multiple partial actuators 43A, 43B, and 43C are disposed in a rotationally symmetrical manner (at 120-degree angular intervals in the present example) with respect to the filter central axis O.

Furthermore, in the present embodiment, the detector 41 is disposed in correspondence with the partial actuators 43A, 43B, and 43C. That is, the detector 41A is disposed outside the partial actuator 43A, the detector 41B is disposed outside the partial actuator 43B, and the detector 41C is disposed outside the partial actuator 43C. The detector 41 are preferably disposed at positions inside the diaphragm 34 where the amount of deformation due to the bend is large. For example, in the present embodiment, the detector 41 are disposed at a surface of the second substrate 12 that is the surface facing the third substrate 13 inside the bottom of the recessed groove but outside the partial actuators 43A, 43B, and 43C in the diaphragm 34.

### Operation of controller 42

The controller 42 detects the amount of deformation of the diaphragm 34 at each of three positions, the position of the detector 41A, the position of the detector 41B, and the position of the detector 41C. The controller 42 therefore calculates the inclination of the second mirror 22 (movable portion 32) by comparing the amounts of deformation of the diaphragm 34 at the three positions with each other. The controller 42 separately controls the operation of driving the partial actuators based on the calculated inclination of the movable portion 32. The controller 42 corrects the inclination of the second mirror 22 by separately driving the partial actuators. The parallelism between the first mirror 21 and the second mirror 22 can therefore be increased.

For example, when the portion where the detector 41A is located is bent by a greater amount than the portions where the detectors 41B and 41C are located, the electric resistance value of the detector 41A is greater than the electric resistance values of the detectors 41B and 41C. In this case, the degree of parallelism of the third substrate 13 can be increased by driving the partial actuator 43A to perform correction in which the position of the detector 41A approaches the second substrate 12.

Note in the embodiments described above that the case where the multiple detector 41 are arranged at the support 31 in a rotationally symmetrical manner, however, it is not limited thereto. For example, the detector 41 may be provided at one of the multiple portions of the support 31.

Even in the configuration in which the diaphragm 34 is provided as the support 31, the configuration in which one of the detector 41 is provided may be employed. In this case, the actuator 43 may be configured with one actuator in place of the three partial actuators. In this case, the actuator 43 is disposed in an annular shape. At least one of the detector 41 is provided in correspondence with the actuator 43 and is disposed at the diaphragm 34.

The wavelength-tunable interference filter 1 in which the diaphragm 34 is formed, which has a simple configuration, can therefore readily control the gap G and widen the range of the wavelength of the spectrally separated light while achieving high accuracy of the wavelength of the spectrally separated light.

Further, in the present embodiment, the detector 41 and the actuator 43 are divided into three portions in a rotationally symmetrical manner, however, it is not limited thereto, and two of the detector 41 and partial actuators may be disposed at 90-degree intervals (in line symmetrical manner), or four or more of the detector 41 and partial actuators may be disposed in rotationally symmetrical manner.

### Effects and advantages of fourth embodiment

(1) In the wavelength-tunable interference filter 1 according to the present embodiment, the controller 42 detects the inclination of the second mirror 22 based on the amount of deformation of the support 31 detected by the detector 41 disposed at at least two of the portions of the support 31 (diaphragm 34), as described above.

The configuration described above allows the amounts of deformation of the diaphragm 34 to be detected at multiple positions. The inclination of the movable portion 32 can be calculated based on the amounts of deformation of the diaphragm 34 at the multiple positions.

(2) In the wavelength-tunable interference filter 1 according to the present embodiment, the actuator 43 includes at least two partial actuators corresponding to the detector 41 disposed at at least two of the portions of the support 31, and the controller 42 separately drives the at least two partial actuators in accordance with the inclination of the second mirror 22, as described above.

The configuration described above allows an increase in the parallelism between the second mirror 22 and the first mirror 21. That is, the controller 42 calculates, from the calculated inclination of the movable portion 32, an amount by which the actuator 43 is driven to correct the inclination. The controller 42 corrects the inclination of the movable portion 32 (second mirror 22) by driving the actuator 43 by the calculated amount. The parallelism of the mirrors can thus be increased, so that a highly accurate wavelength-tunable interference filter 1 can be provided.

In addition, disposing the detector 41 at the diaphragm 34 allows an increase in the range over which the actuator 43 can be disposed as compared with the case where the detector 41 is disposed at the movable portion 32. The range over which the movable portion 32 can be moved in a stable manner is therefore increased. The wavelength sweeping range of the wavelength-tunable interference filter 1 can therefore be widened.

### Variation 1

In the first embodiment, the detector 41 is disposed only at the front surface of the second substrate 12, however, it is not limited thereto, and may be disposed only at the rear surface of the second substrate 12. Similarly, the detectors 52A, 53A, and 54A may be disposed at the rear surface of the second substrate 12.

For example, in FIGS. 2, 3, 5, and 12, the detector is disposed only at the front surface of the second substrate 12, and may also be disposed only at the rear surface thereof.

### Variation 2

In the first embodiment described above, the actuator 43 is disposed at the second substrate 12 and the third substrate 13, however, it is not limited thereto. For example, the third substrate 13 may not be provided, and the actuator 43 may be disposed at the first substrate 11 and the second substrate 12.

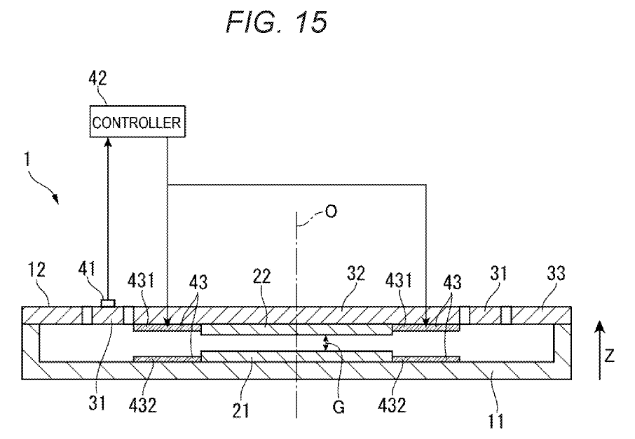

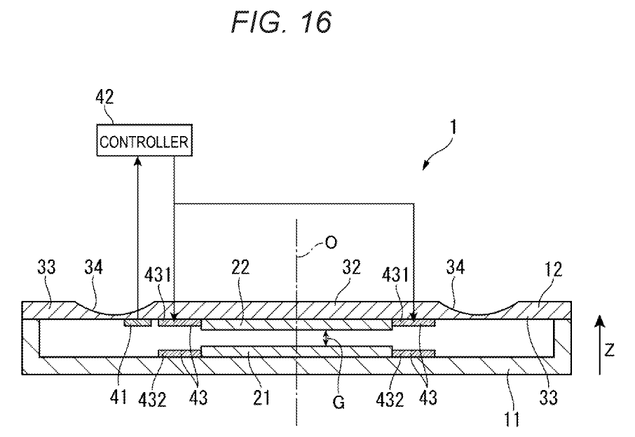

FIG. 15 is a cross-sectional view showing a schematic configuration of a wavelength-tunable interference filter 1 according to Variation 2. FIG. 16 is a cross-sectional view showing another example of the wavelength-tunable interference filter 1 according to Variation 2.

In the wavelength-tunable interference filters 1 shown in FIGS. 15 and 16, the actuator 43 includes the first electrode 431 provided at the movable portion 32 and the second electrode 432 disposed at the first substrate 11 so as to face the first electrode 431. In this case, applying a voltage to the actuator 43 causes the movable portion 32 to be displaced so as to approach the first substrate 11, so that the size of the gap G is changed. As the support 31, the beam-shaped support 31 may be used as shown in FIG. 15, or the diaphragm 34 may be used as shown in FIG. 16.

The thus configured wavelength-tunable interference filter 1 can therefore also readily control the gap G and widen the range of the wavelength of the spectrally separated light while achieving high accuracy of the wavelength of the spectrally separated light.

### Variation 3

In the first embodiment, the detector 41 is disposed at the boundary between the first piece 311 and the second piece 312, however, it is not limited thereto, and may be disposed at other positions. For example, the detector 41 may be disposed at the second piece 312 or may be disposed at the boundary between the second piece 312 and the third piece 313. Even when the detector 41 is disposed at the third piece 313, the displacement of the support 31 can be detected.

### Variation 4

In the first embodiment, the detectors 41A, 41B, 41C, and 41D constitute separate detection circuits 5, however, it is not limited thereto, and at least one detection circuit 5 may be formed. Multiple portions of the support 31 are provided, and the detector 41 is disposed at any one of the multiple portions of the support 31. One of the detector 41 may be disposed at at least one of the multiple portions of the support 31. In addition, the detection circuit 5 may be configured only with the detector 41. In the configuration described above, one element constitutes the detector 41. The configuration can therefore be simplified.

### Variation 5

In the first embodiment, the detector 41 is configured with a resistor such as a piezoelectric resistor, however, it is not limited thereto, and may be configured with a piezoelectric element. In this case, the piezoelectric element provided at the support 31 is deformed by the deformation of the support 31, so that an electric signal according to the amount of deformation is output from the piezoelectric element. The amount of bend of the support 31 can therefore be detected without forming a Wheatstone bridge circuit as the detection circuit 5.

### Variation 6

In the first embodiment, the controller 42 stores table data in the storage, the table data indicating the relationship between the average of the electrical resistance values R1 of the detector 41 and the size of the gap G, however, it is not limited thereto.

For example, the size of the gap G corresponding to the average of the output voltages E₀output from the detection circuits 5 may be stored in the storage in advance as the table data. In this case, the controller 42 can directly acquire the size of the gap G based on the average of the output voltages E₀ output from the detection circuits 5.

Alternatively, the amounts of bendings at the portions of the support 31 may be calculated based on the output voltages E₀ output from the detection circuits 5 or the electric resistance values R1 of the detector 41 calculated based on the output voltages E₀ output from the detection circuits 5. In this case, table data indicating the relationship between the electrical resistance value R1 of the detector 41 and the amount of bend of the support 31 or table data indicating the relationship between the output voltage E₀ and the amount of bend of the support 31 may be stored in the storage.

### Summary of present disclosure

A wavelength-tunable interference filter according to a first aspect of the present disclosure includes: a first substrate on which a first mirror is disposed; a movable portion including a second mirror facing the first mirror; a support configured to support the movable portion in a way that the movable portion is movable forward and rearward with respect to the first mirror; an outer peripheral section configured to hold the movable section via the support, an actuator configured to change a size of a gap between the first mirror and the second mirror; a detector provided at the support and configured to detect an amount of deformation of the support; and a controller, and the controller is configured to calculate the size of the gap based on the amount of deformation detected by the detector and drive the actuator based on the calculated size of the gap.

In the aspect described above, it is preferable that the detector is disposed at both a front surface and a rear surface of the support.

In the aspect described above, it is preferable that the detector is disposed at one of a front surface and a rear surface of the support.

In the aspect described above, it is preferable that the multiple detectors are provided, and that the multiple detectors are coupled to each other to form one detection circuit.

In the aspect described above, it is preferable that the detector is a resistor having a resistance value that changes in accordance with the amount of deformation of the support, and that the controller is configured to calculate the size of the gap based on the resistance value of the resistor.

In the aspect described above, it is preferable that the detector is configured with a piezoelectric resistor.

In the aspect described above, it is preferable that the detector is configured with a metal film.

In the aspect described above, it is preferable that the detector constitutes a portion of a Wheatstone bridge circuit.

In the aspect described above, it is preferable that the support is configured with multiple supports, and that the detector is disposed at any one of the multiple supports.

In the aspect described above, it is preferable that the multiple supports are each provided with a first wiring in which a conductive wire is disposed, that the movable portion is provided with a second wiring in which a conductive wire is disposed, and that the detector is electrically coupled to the conductive wire disposed in the first wiring and the conductive wire disposed in the second wiring.

In the aspect described above, it is preferable that the support is configured with multiple supports, and that the detector is disposed at at least two of the supports.

In the aspect described above, it is preferable that the wavelength-tunable interference filter further includes a reference detector disposed for reference purposes with respect to the detector, that the multiple supports are each provided with a first wiring in which a conductive wire is disposed, that the movable portion is provided with a second wiring in which a conductive wire is disposed, and that the detector is electrically coupled to the conductive wire disposed in the first wiring, the conductive wire disposed in the second wiring, and the reference detector.

In the aspect described above, it is preferable that the controller is configured to calculate an average of the amounts of deformation detected by the detectors disposed at the at least two supports, and calculate the size of the gap based on the average.

In the aspect described above, it is preferable that the controller is configured to detect inclination of the second mirror based on the amounts of deformation of the at least two of the supports detected by the detectors disposed at the supports.

In the aspect described above, it is preferable that the actuator includes at least two partial actuators corresponding to the detectors disposed at the at least two supports, and that the controller is configured to separately drive the at least two partial actuators in accordance with the inclination of the second mirror.

What is claimed is:

1. A wavelength-tunable interference filter comprising:
a first substrate on which a first mirror is disposed;
a movable portion including a second mirror facing the first mirror;
a support configured to support the movable portion in a way that the movable portion is movable forward and rearward with respect to the first mirror;
an outer peripheral portion configured to hold the movable portion via the support;
an actuator configured to change a size of a gap between the first mirror and the second mirror;
a detector provided at the support and configured to detect an amount of deformation of the support; and
a controller,
wherein the controller is configured to calculate the size of the gap based on the amount of deformation detected by the detector and drive the actuator based on the calculated size of the gap.

2. The wavelength-tunable interference filter according to claim 1, wherein
the detector is disposed at both a front surface and a rear surface of the support.

3. The wavelength-tunable interference filter according to claim 1, wherein
the detector is disposed at one of a front surface and a rear surface of the support.

4. The wavelength-tunable interference filter according to claim 1, wherein
the multiple detectors are provided, and
the multiple detectors are coupled to each other to form one detection circuit.

5. The wavelength-tunable interference filter according to claim 1, wherein
the detector is a resistor having a resistance value that changes in accordance with the amount of deformation of the support, and
the controller is configured to calculate the size of the gap based on the resistance value of the resistor.

6. The wavelength-tunable interference filter according to claim 5, wherein
the detector is configured with a piezoelectric resistor.

7. The wavelength-tunable interference filter according to claim 5, wherein
the detector is configured with a metal film.

8. The wavelength-tunable interference filter according to claim 5, wherein
the detector constitutes a portion of a Wheatstone bridge circuit.

9. The wavelength-tunable interference filter according to claim 1, wherein
the support is configured with multiple supports, and
the detector is disposed at any one of the multiple supports.

10. The wavelength-tunable interference filter according to claim 9, wherein
the multiple supports are each provided with a first wiring in which a conductive wire is disposed,
the movable portion is provided with a second wiring in which a conductive wire is disposed, and
the detector is electrically coupled to the conductive wire disposed in the first wiring and the conductive wire disposed in the second wiring.

11. The wavelength-tunable interference filter according to claim 1, wherein
the support is configured with multiple supports, and
the detector is disposed at at least two of the supports.

12. The wavelength-tunable interference filter according to claim 11, further comprising
a reference detector disposed for reference purposes with respect to the detector,
wherein the multiple supports are each provided with a first wiring in which a conductive wire is disposed,
the movable portion is provided with a second wiring in which a conductive wire is disposed, and
the detector is electrically coupled to the conductive wire disposed in the first wiring, the conductive wire disposed in the second wiring, and the reference detector.

13. The wavelength-tunable interference filter according to claim 11, wherein
the controller is configured to calculate an average of the amounts of deformation detected by the detectors disposed at the at least two supports, and calculate the size of the gap based on the average.

14. The wavelength-tunable interference filter according to claim 11, wherein
the controller is configured to detect inclination of the second mirror based on the amounts of deformation of the at least two of the supports detected by the detectors disposed at the supports.

15. The wavelength-tunable interference filter according to claim 14, wherein
the actuator includes at least two partial actuators corresponding to the detectors disposed at the at least two supports, and
the controller is configured to separately drive the at least two partial actuators in accordance with the inclination of the second mirror.
